(19) United States
(12) Patent Application Publication
(10) Pub. No.: US 2024/0427303 A1
(43) Pub. Date: Dec. 26, 2024

(54) DECISION UNIT FOR FAIL OPERATIONAL SENSORS

(71) Applicants: Bosch Car Multimedia Portugal, S.A., Braga (PT); Universidad Do Minho, Braga (PT)

(72) Inventors: Jorge Miguel NUNES DOS SANTOS CABRAL, São Tomé de Abacão (PT); Álvaro Miguel SANTOS MAGALHÃES, Porto (PT); Fábio André DA COSTA LEITÃO, Gondifelos (PT); Jens OTTERBACH, Ludwigsburg (DE); João António GONCALVES DE SOUSA MARQUES, Porto (PT); José António AZEVEDO GONCALVES, Arcozelo BCL (PT); Luis Miguel MARINHO NOVAIS, Guimarães (PT); Marco António DA SILVA ESTEVES, Braga (PT); Rui Manuel PEIXOTO FARIA, Braga (PT)

(21) Appl. No.: 18/707,036

(22) PCT Filed: Nov. 4, 2021
(86) PCT No.: PCT/IB2021/060222

§ 371 Date: May 2, 2024

(30) Foreign Application Priority Data
Nov. 2, 2021 (PT) 117540

(51) Int. Cl. G05B 19/042

(52) U.S. Cl. CPC G05B 19/0428; G05B 2219/24125

(57) ABSTRACT

The present application describes a supervision and decision hardware unit compatible with redundant-based sensors architectures, targeting a fail operational sensor design. The herein disclosed invention describes a supervision and decision unit, based on a “decision block” embedded in a redundant sensor architecture, allowing the supervision of each isolated subsystem. Beyond that, each isolated subsystem is able to provide the full required information of sensor and indicate the operation state of each independent subsystem. This unit is developed to be incorporated in a fail operation sensor design, including supervision and circuitry independency, and promoting sharing of data through a galvanic isolated communication.

### TECHNICAL FIELD

The present application describes a supervision and decision hardware unit compatible redundant-based sensors architectures, targeting a fail operational sensor design.

### BACKGROUND ART

The current progress and evolution of the automotive industry, leading to the development of electric and hybrid-electric vehicles (EVs and HEVs), has motivated the development of autonomous driving systems and drive-by-wire applications.

This trend has risen a set of most constricted requirements in terms of signal availability and safety levels in the field of automotive sensors. The typical “fail-safe” sensor behavior, entering in a “safe state” when faulty (normally stop the operation), becomes an ineffective solution when incorporated into these applications.

### SUMMARY

Present invention describes a supervision and decisioning unit comprising two independent subsystems, subsystem A and subsystem B; and two galvanic isolators installed between the two independent subsystems; wherein the two independent subsystems are configured to receive input signals from an external source through two sensing elements and provide sensor information and status based on said input signals.

In a proposed embodiment of present invention, each of the two independent subsystems comprise a watchdog timer, a microcontroller, a logic gate and a transceiver.

Yet in another proposed embodiment of present invention, each of the two independent subsystems are configured to share data through a communication channel and an isolated feedback channel.

Yet in another proposed embodiment of present invention, the shared data through the communication channel and the isolated feedback channel is adapted and secured by galvanic isolators so the sensor information and status is detected by each of the two independent subsystems.

Yet in another proposed embodiment of present invention, the supervision and decisioning unit comprises a latch circuit in each of the two independent subsystems.

Yet in another proposed embodiment of present invention, the sensor information and status comprises a normal status and a fail operation status.

Yet in another proposed embodiment of present invention, the watchdog timer is supervise the configured to microcontroller for a failure processing.

Yet in another proposed embodiment of present invention, the microcontroller is configured to acquire data from the sensing elements and modify the sensor information and status to a fail operational status, leaving active only one of the independent subsystems and the latch circuit, preserving the fail operational status until a next reboot of the unit.

Yet in another proposed embodiment of present invention, the microcontroller comprises a microcontroller enable, an enable pin and a watchdog input pin output signals.

Yet in another proposed embodiment of present invention, the microcontroller is configured to perform an initialization routine, implementing a sanity check, before the microcontroller enable outputs the sensor information and status as well as the watchdog timer through the enable pin.

Yet in another proposed embodiment of present invention, the microcontroller is configured to periodically acquire and process the signals from the sensing elements, and in case of a timeout event on the watchdog timer, indicating a failure in data processing, causes a reset event which is detected by the remaining independent subsystem through the galvanic isolators.

Yet in another proposed embodiment of present invention, the watchdog timer is adapted to supervise the microcontroller through refresh frames of the watchdog input pin, while providing a valid watchdog output signal to the reset line and to the logic gate.

Yet in another proposed embodiment of present invention, the logic gate output is dependent of its input signals and is adapted to control the “stand-by” signal of the transceiver and consequently the state of the isolated feedback channel.

### General Description

The present application describes a supervision and decision hardware unit designed to target fail operational sensors.

The developed unit comprises two independent galvanically isolated subsystems able to measure an external source through two sensing elements which are adapted to provide system operation status based on data processing state and other mechanisms for failures detection.

Hereupon, this next generation of applications demands the sensors to keep their required functionality, even in the occurrence of a failure, leading to a new standard: the fail operational sensors.

The herein disclosed invention describes a supervision and decision unit, based on a “decision block” embedded in a redundant sensor architecture, allowing the supervision of each isolated subsystem. Beyond that, each isolated subsystem can provide information about their individual operation and functional status to the other independent subsystem. This unit is developed to be incorporated in a fail operation sensor design, including supervision and circuitry independency, and promoting sharing of data through a galvanic isolated communication.

One of the strategies to achieve a fail operational solution is based on the increasing system redundancy where independent sources must provide the equivalent information. In addition, failures monitors are needed to evaluate the reliability of each independent source. The sensor must keep its full functionality even in the occurrence of a failure.

The proposed decision unit allows each independent measurement or sensing source to evaluate its own data integrity, preventing the flow of invalid information and giving the indication of its operational status to other independent subsystem.

Based on that information, the remaining valid independent subsystem can reconfigure itself to assure the expected signal availability and safety level and to give indication to the upper system about its “fail operation” mode status.

One of the major advantages of this galvanically isolated architecture is the prevention of common cause failures related to power supply failures: undervoltage, overvoltage, short circuits, among others. Additionally, this unit gives the chance to extend the sensor redundancy to external independent power source units and independent communication buses.

The developed unit comprises a simple hardware arrangement design when compared to other existing solutions with complex redundant architectures using several microcontrollers in a voting system.

### BRIEF DESCRIPTION OF THE DRAWINGS

For better understanding of the present application, figures representing preferred embodiments are herein attached which, however, are not intended to limit the technique disclosed herein.

FIG. 1—illustrates the operational concept of the supervision system based on two similar subsystems, Subsystem A (11) and Subsystem B (12). In the illustrated example, both Subsystem A (11) and Subsystem B (12) represent a correct and operational status.

FIG. 2—illustrates the operational concept of the supervision system based on two similar subsystems, Subsystem A (11) and Subsystem B (12). In the illustrated example, Subsystem A (11) represents a failure status and Subsystem B (12) represents an operational status receiving “feedback” of this failure indication.

FIG. 3—illustrates the operational concept of the supervision system based on two similar subsystems, Subsystem A (11) and Subsystem B (12). In the illustrated example, Subsystem A (11) represents a failure status and Subsystem B (12) represents an operational status but with a flagged Fail Operation remark.

FIG. 4—illustrates the proposed supervision and decision unit, where the reference numbers refer to:

1—supervision and decisioning unit;
2—external source;
11—side A/Subsystem A;
12—side B/Subsystem B;
21—sensing element A;
22—sensing element B;
23—galvanic isolator for “stand-by” state;
24—galvanic isolator for microcontrollers “Keep Alive”;
31—upper system interface/sensor information and status;
32—upper system interface/sensor information and status;
111—watchdog timer A (WD_A);
112—uC A/microcontroller A;
113—logic gate AND A;
114—latch circuit A;
115—transceiver A;
121—watchdog timer B (WD_B);
122—uC B/microcontroller B;
123—logic gate AND B;
124—latch circuit B;
125—transceiver B;
1121—keep alive/communication channel A;
1122—enable A (EN_A);
1123—watchdog input A (WDI_A);
1124—watchdog output A (WDO_A);
1125—microcontroller enable A;
1126—reset A (RST_A);
1141—transceiver “stand-by” signal A;
1142—isolated feedback channel A;
1143—latch circuit A reset;
1221—keep alive/communication channel B;
1222—enable B (EN_B);
1223—watchdog input B (WDI_B);
1224—watchdog output B (WDO_B);
1225—microcontroller enable B;
1226—reset B (RST_B);
1241—transceiver “stand-by” signal B;
1242—isolated feedback channel B;
1243—latch circuit B reset.

### DESCRIPTION OF EMBODIMENTS

With reference to the figures, some embodiments are now described in more detail, which are however not intended to limit the scope of the present application.

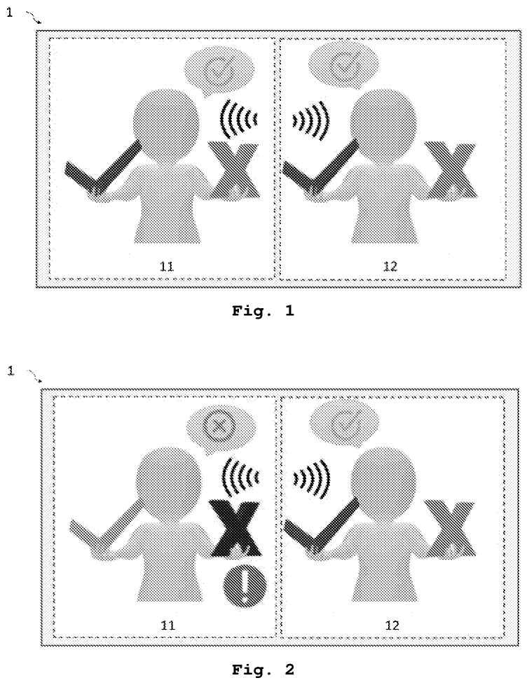

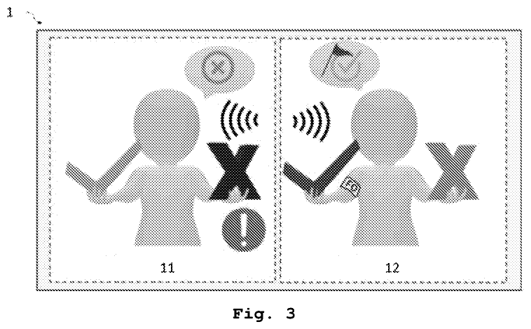

The supervision system (1) illustrated on FIG. 1, FIG. 2 and FIG. 3, comprises two subsystems, Subsystem A (11) and Subsystem B (12). Each subsystem (11, 12) of the supervision and decisioning unit (1) is responsible to ensure the supervision of its own components, detecting its own failures; communicate its own operational status and listen to other branch's status.

As illustrated in FIG. 2, the faulty Subsystem A (11) is responsible to block the output interface preventing the erroneous information flow from its own side. As the remaining operational Subsystem B (12) is able to acknowledge the faulty status of Subsystem A (11), it will change its operational status to Fail Operation (FO) mode. This will lead the Subsystem B (12) to reconfigure itself to assure the full system functionality providing the required information to the upper system but flagging the information of a fail-degraded status, as suggested in FIG. 3.

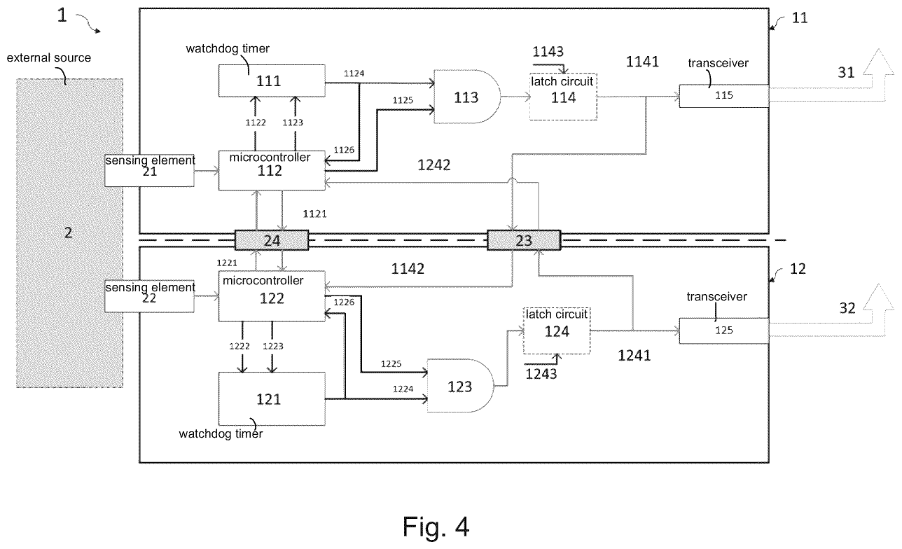

Based on this behaviour, and resorting to the analysis of FIG. 4, the supervision and decisioning unit (1) comprises two subsystems, Subsystem A (11) and Subsystem B (12). Each of the subsystems (11, 12) will receive external input data/signals from external sources (2) through sensing elements, particularly Subsystem A (11) will receive input data through sensing element A (21), and Subsystem B (12) will receive input data through sensing element B (22). Both of these sensing elements (21, 22) are responsible for translating external sources (2) or signal variations which can comprise magnetic variations, optical variations, inductive variations, etc.

Subsystem A (11) comprises a watchdog timer A (111), a microcontroller A (112), a logic gate A (113) and a transceiver A (115). Additionally, it may include a latch circuit A (114) between the logic gate A (113) and the transceiver A (115). The microcontroller A (112) will read/acquire data inputs from sensing element A (21), being adapted to provide output signals and commands to the microcontroller B (122) through the communication channel A (1121); to the watchdog timer A (111) through the enable A (1122) and the watchdog input A (1123); and to the logic gate A (113) through the microcontroller enable A (1125). In turn, the watchdog timer A (111) is adapted to provide output signals and commands to the microcontroller A (112) through the RST_A (1126) and to the logic gate A (113) through the watchdog output A (1124). The logic gate A (113) in its turn, will provide a logic result, transceiver “stand-by” signal A (1141), dependent of both input signals, the watchdog output A (1124) and the microcontroller enable A (1125). The transceiver “stand-by” signal A (1141) will be responsible for activating the transceiver A (115) to provide the sensor information and status (31) of the subsystem A (11), and also to provide isolated feedback A (1142) to the microcontroller B (122) of subsystem B (12).

In a mirrored way, Subsystem B (12) comprises a watchdog B (121), a microcontroller B (122), a logic gate B (123) and a transceiver B (125). Additionally, it may include a latch circuit B (124) between the logic gate B (123) and the transceiver B (125). The microcontroller B (122) will read/acquire data inputs from sensing element B (22), being adapted to provide output signals and commands to the microcontroller A (112) through the communication channel B (1221); to the watchdog timer B (121) through the enable B (1222) and the watchdog input B (1223); and to the logic gate B (123) through the microcontroller enable B (1225). In turn, the watchdog timer B (121) is adapted to provide output signals and commands to the microcontroller B (122) through the RST_B (1226) and to the logic gate B (123) through the watchdog output B (1224). The logic gate B (123) in its turn, will provide a logic result, transceiver “stand-by” signal B (1241), dependent of both input signals, the watchdog output B (1224) and the microcontroller enable B (1225). The transceiver “stand-by” signal B (1241) will be responsible for activating the transceiver B (125) to provide the sensor information and status (32) of the subsystem B (12), and also to provide an isolated feedback B (1242) to the microcontroller A (112) of subsystem A (11).

The unit (1) comprises also a set of galvanic isolators (23, 24) allowing communication while keeping the electrical insolation of both mirrored subsystems A and B (11, 12).

Both microcontrollers A and B (112, 122) implement safety monitors and features for failures detection reflecting their state in a digital signal, the microcontroller enable (1125, 1225). This digital signal comprises information related to system (1) initialization, sensing elements (21, 22) acquisition status, data processing availability and internal safety features.

Each watchdog timer (111, 121) supervises its related microcontroller (112, 122) expecting to receive refresh frames through its input pins WDI (1123, 1223), while keeping a valid watchdog output (1124, 1224). Although the microcontrollers (112, 122) can have an internal watchdog timer, an independent part (111, 121) is needed to prevent any failure during microcontroller's data processing. The logic gates (113, 123) combine both signals, microcontroller enable (1125, 1225) and watchdog output (1124, 1224), controlling the enable status of the transceivers (115, 125) through the “stand-by” signals (1141, 1241) that interfaces the upper system with sensor information and status (31, 32), as well as the subsystem information flow.

The microcontroller (112, 122) enables the watchdog timer (111, 121) during the initialization phase. When enabled, the WDI (1123, 1223) must be refreshed so it can keep a valid status on the WDO (1124, 1224) line, preventing a timeout event. The watchdog's (111, 121) timeout state is indicated when the WDO (1124, 1224) signal is asserted, meaning that the microcontroller (112, 122) is no longer operational. On the other hand, after a valid initialization and assuming a normal operation, the microcontrollers (112, 122) perform, in a periodical process, readings/data acquisition from the sensing elements (21, 22) as well as data processing and transmission.

The transceiver (115, 125), and therefore the flow of messages provided to the data bus, is only enabled if both input variables provided by the WDO (1124, 1224) and the microcontroller enable (1125, 1225) signals indicate a correct functional status. Otherwise, an invalid combination deactivates the transceiver “stand-by” signal (1141, 1241), blocking the data transmission. The correlation between the decision unit (1) status based on these input variables and the operation mode is shown in table 1.

TABLE 1

| | External | Transceiver | Subsystem |
|---|---|---|---|
| Microcontroller | watchdog | “stand by” | (11, 12) |
| enabled? | (111, 121) | (1141, 12411) | operation |
| (1125, 1225) | timeout? | enabled? | status (31, 32) |
| YES | YES | YES | Fall Op. |
| YES | NO | NO | Normal |
| NO | YES | YES | Fall Op. |
| NO | NO | YES | Fall Op. |

As shown, the fail operation mode is asserted by the subsystem (11, 12) whenever there is a malfunction indication provided by the microcontroller (112, 122) or the watchdog (111, 121).

Moreover, taking advantage of galvanic isolators (23), for example optocouplers, capacitive or inductive digital isolators, an isolated feedback channel (1142, 1242) is used so the operation status is detected by the other independent subsystem. Consequently, this last one can continue to operate, keeping the system (1) functionality and subsequently, giving the faulty event indication to the upper system.

With the proposed supervision and decision unit (1), two possible embodiments/configurations are to be considered, a latched decision and a not latched decision.

On the latched decision configuration, the latch circuit block (114, 124) is reset (1143, 1243) to a valid state when the system starts. This can be done by the microcontroller (112, 122) after a valid initialization routine is performed or, through a hardware delay circuit during system (1) power up. When the microcontroller (112, 122) detects a failure or when the watchdog timer (111, 121) is timed out, the system (1) goes into fail operational mode, resulting in only one of the independent circuitry/subsystem (11 or 12) being active. The latch circuit (114, 124) preserves this defective status, and the faulty subsystem (11 or 12) remains disconnected until the next power cycle or system (1) reboot. Only after a new power reboot, the faulty subsystem (11 or 12) can operate again if it reveals valid after initialization.

On the not-latched decision configuration, when the system (1) turns on, the microcontroller (112, 122) initialization routine should implement a sanity check before the microcontroller enable (1125, 1225) indicates a valid status and enables the watchdog timer (111, 121) through enable pin (1122, 1222). If a failure event occurs, causing the timeout of the watchdog timer (111, 121), the system (1) goes into fail operational mode, resulting in only one of the independent circuitry/subsystem (11 or 12) being active. After the watchdog (111, 121) resets the microcontroller (112, 122), it can run the sanity check routine again. As the other independent subsystem (11 or 12) is able to detect this reset event through the isolator (23), it is reconfigured to keep the full functionality of the system (1) but giving the indication of the “fail operation mode” state until receives a successful recover indication from the previous faulty subsystem (11 or 12).

Besides this sensor information and status (31, 32), an additional communication channel (1121, 1221) also based in galvanic isolation principle is added for “keep alive” indication, data exchange and synchronization between subsystems (11, 12).

1-13. (canceled)

14. A supervision and decision unit, comprising:
two independent subsystems; and
two galvanic isolators installed between the two independent subsystems;
wherein the two independent subsystems are configured to receive input signals from an external source through two sensing elements and provide sensor information and status based on the received input signals.

15. The supervision and decision unit according to claim 14, wherein each of the two independent subsystems includes a watchdog timer, a microcontroller, a logic gate, and a transceiver.

16. The supervision and decision unit according to claim 15, wherein each of the two independent subsystems are configured to share data through a communication channel and an isolated feedback channel.

17. The supervision and decision unit according to claim 16, wherein the shared data through the communication channel and the isolated feedback channel is adapted and secured by galvanic isolators so the sensor information and status is detected by each of the two independent subsystems.

18. The supervision and decision unit according to claim 15, further comprising a latch circuit in each of the two independent subsystems.

19. The supervision and decision unit according to claim 14, wherein the sensor information and status include a normal status and a fail operation status.

20. The supervision and decision unit according to claim 15, wherein the watchdog timer is configured to supervise the microcontroller for a failure processing.

21. The supervision and decision unit according to claim 18, wherein the microcontroller is configured to acquire data from the sensing elements and to modify the sensor information and status to a fail operational status, leaving active only one of the independent subsystems and the latch circuit, preserving the fail operational status until a next reboot of the unit.

22. The supervision and decision unit according to claim 15, wherein each of the microcontrollers includes a microcontroller enable, an enable pin, and a watchdog input pin.

23. The supervision and decision unit according to claim 22, wherein each of the microcontrollers is configured to perform an initialization routine, implementing a sanity check before the microcontroller enable outputs the sensor information and status, and to enable the watchdog timer through the enable pin.

24. The supervision and decision unit according to claim 15, wherein each of the microcontrollers is configured to periodically acquire and process the signals from the sensing elements, and in case of a timeout event on the watchdog timer, indicating a failure in data processing, causes a reset event which is detected, through the galvanic isolators, by the independent subsystem that includes the other of the microcontrollers.

25. The supervision and decision unit according to claim 15, wherein each watchdog timer is adapted to supervise the microcontrollers through refresh frames of the watchdog input pin, while providing a valid watchdog output signal to a reset line and to the logic gate.

26. The supervision and decision unit according to claim 16, wherein the logic gate is adapted to control a “stand-by” signal of the transceiver and consequently a state of the isolated feedback channel.
